(19) United States
(12) Patent Application Publication
(10) Pub. No.: US 2004/0239813 A1
(43) Pub. Date: Dec. 2, 2004

(54) Method of and display processing unit for displaying a colour image and a display apparatus comprising such a display processing unit

(76) Inventor: Michiel Adriaanszoon Klompenhouwer, Eindhoven (NL)

Correspondence Address: Philips Electronics North America Corporation, P O Box 3001, 345 Scarborough Road, Briarcliff Manor, NY, 10510, US

(21) Appl. No.: 10/492,665

(22) PCT Filed: Oct. 14, 2002
(86) PCT No.: PCT/IB02/04227

(30) Foreign Application Priority Data
Oct. 19, 2001 (EP) 01204003.6

(51) Int. Cl. H04N 9/66

(52) U.S. Cl. 348/638

(57) ABSTRACT

By taking into account the individual positions of the sub-pixels (108-118) on a color matrix display device (100); the apparent resolution can be increased. Sub-pixel sampling to determine samples at the correct position is incorporated in the image scaling filter (502). The filter response is such that the useful resolution inherent in the color matrix display device (100) can be used. In the filter design, a trade-off is made between sharpness and color errors.

The scaling (216) is performed on e.g. a YUV signal, thereby saving bandwidth. The luminance signal Y is e.g. sub-sampled at high sub-pixel resolution, and the U and V components at pixel resolution. The sub-pixel positions are then taken into account in the YUV to RGB conversion (218).

The invention relates to a method of displaying an image on a color matrix display device.

The invention further relates to a display processing unit for displaying an image on a color matrix display device.

The invention further relates to a display apparatus comprising:

a receiver for receiving an image;

a display processing unit for displaying an image on a color matrix display device; and

the color matrix display device.

Matrix display devices, such as LCDs, PDPs and PolyLEDs, offer the potential of reaching a very high image quality with a very convenient and/or fashionable (lightweight, flat, large) screen. Matrix display devices provide the viewer with an image that is as sharp at the corners as it is in the center. A particular disadvantage of a matrix display device is its fixed resolution, which makes image scaling prior to display a necessity.

EP 0974953A1 discloses that the apparent resolution of a matrix display device can be increased by profiting from one of its characteristics: the fact that each full color pixel actually consists of a number of, spatially displaced, color sub-pixels. When each pixel is used as a group of three sub-pixels, then on the display the red and blue sub-pixels must be shifted relative to the green sub-pixel by ⅓ of a pixel size. A filter is described that realizes this shift by delaying the color component signals in the image relative to each other. An embodiment of the system according to the prior art aims at profiting from higher resolution by taking into account the actual position of the sub-pixels in the process of converting a high resolution input signal to the display resolution. The image scaling is specifically tuned to the arrangement of sub-pixels on the display. The underlying principle is that a value of a color component that is valid at the position where it is actually displayed is used, in stead of a value of the color component at the position of the corresponding full color pixel.

It is a first object of the invention to provide a method of displaying an image, with a relatively high resolution.

It is a second object of the invention to provide a display processing unit for displaying an image, with a relatively high resolution.

It is a third object of the invention to provide a display apparatus for displaying an image, with a relatively high resolution.

The first object of the invention is achieved in that the method of displaying an image on a color matrix display device which comprises multiple pixels, each comprising sub-pixels corresponding to predetermined colors, the image being represented by an image signal comprising a luminance component, a first color difference component and a second color difference component, the method comprising:

a scaling step to scale the image to an intermediate image represented by a further image signal comprising an intermediate luminance component, a first intermediate color difference component and a second intermediate color difference component, with scaling of the luminance component related to a sub-pixel resolution which is related to a number of sub-pixels of the color matrix display device;

a conversion step to calculate signal values for a particular pixel to be provided to respective sub-pixels of the particular pixel based on samples of the intermediate luminance component, the first intermediate color difference component and the second intermediate color difference component;

a display step in which the signal values are provided to the respective sub-pixels of the particular pixel.

The most important aspect of the invention is that the sub-pixel resolution of the color matrix display device is taken into account in the scaling of the image which is represented by the luminance component, the first color difference component and the second color difference component. After the scaling the conversion to signal values which can be provided to the sub-pixels is performed. For example, with an embodiment of the method according to the invention a scaling step to the appropriate resolution is performed on the YUV components in stead of on the red, green and blue color components (RGB). The conversion from YUV components to RGB components is executed after the scaling step. The result is that the number of operations is less compared with sub-pixel scaling after conversion. The method according to the prior art deals with scaling of RGB components and not of scaling with luminance and color difference components. Processing YUV components of video signals is more common than processing RGB components. Especially for television, video signals are stored using a combination of a luminance and two chrominance components rather than red, green and blue color components. In other words, in the video standards YUV, YIQ or YCBCR components are used instead of RGB components. For example, the YUV signal comprises a luminance component Y and two chrominance or color difference components U and V. The bandwidth of a video signal can be reduced by transmitting the U and V components with reduced bandwidth compared to the Y component, i.e. with less samples. This construction matches relatively well to human perception, since the human vision system is much more sensitive to luminance than to color. Typical formats are called 4:2:2 and 4:2:0 meaning that there are only half as many U and V samples horizontally, and horizontally and vertically, respectively.

It is possible to scale the luminance component, the first color difference component and the second color difference component to the sub-pixel resolution. But in a preferred embodiment of the method of displaying an image according to the invention, the first color difference component and the second color difference component are scaled to the first intermediate color difference component and the second intermediate color difference component respectively, both having a pixel resolution of the color matrix display device, which is related to a number of pixels of the color matrix display device. The advantage is that less computations are required.

In an embodiment of the method of displaying an image according to the invention, a particular signal value of a particular sub-pixel is calculated based on a first sample of the intermediate luminance component and a second sample of the first intermediate color difference component. The information about the actual position of the sub-pixels is used in the conversion step, e.g. YUV to RGB. For example, the Y component is scaled to three times the pixel resolution, i.e. the sub-pixel resolution, and the U and V components are scaled to the pixel resolution. The filtering on Y must make the tradeoff between sharpness and color errors, by choosing the right cut-off frequency, which is typically just above the pixel resolution, i.e. Nyquist frequency. The full resolution on the Y signal after scaling is therefore not necessarily used. For each pixel of the color matrix display device there are three Y samples, one U sample and one V sample. The conversion step becomes:

R=Y₁+1.4V

G=Y₂−0.332U−0.712V

B=Y₃+1.78U

Where Y, Y₂ and Y₃ are luminance samples at positions which are in the neighborhood of the red, green and blue sub-pixels, respectively, and where U and V are chrominance samples at a position which is in the neighborhood of the center of the particular pixel. The advantage of this embodiment is that the conversion step is relatively easy. Another advantage of this embodiment is that the scaling step and the conversion step are relatively independent. In the scaling step, samples are calculated and in the conversion step those samples are used which are relatively close to the actual position of the sub-pixels. The RGB to YUV conversion matrix is an example which is related to the video standard and RGB color points. Other matrices are applicable for other standards.

An embodiment of the method of displaying an image according to the invention is characterized in that in the scaling step the first sample of the intermediate luminance component is calculated by taking into account a location of the particular sub-pixel. Preferably, e.g. the Y samples are calculated for the sub-pixel positions, and the U and V samples are calculated for the central sub-pixel position of a pixel. The conversion step becomes:

R=Y_{R}+1.4V

G=Y_{G}−0.332U−0.712V

B=Y_{B}+1.78U

Where Y_{R}, Y_{G} and Y_{B} are luminance samples at positions which are substantially at the position of the red, green and blue sub-pixels, respectively, and where U and V are chrominance samples at a position which is substantially at the position of the center of the particular pixel. An advantage of this embodiment is that the image quality is relatively high.

In an embodiment of the method of displaying an image according to the invention, the particular signal value of the particular sub-pixel is calculated based on an interpolation of multiple samples of the intermediate luminance component. This means e.g. that in the conversion, not a single Y sample is used, but an average of a number of Y samples. Preferably a weighted average is used. This complicates the conversion, but the scaling step may be simplified, e.g. by taking a lower scaling factor. Also, the U and V samples can be interpolated to the correct position.

Modifications of the method and variations thereof may correspond to modifications and variations thereof of the display processing unit described.

These and other aspects of the method and display processing unit and of the display apparatus according to the invention will become apparent from and will be elucidated with respect to the implementations and embodiments described hereinafter and with reference to the accompanying drawings, wherein:

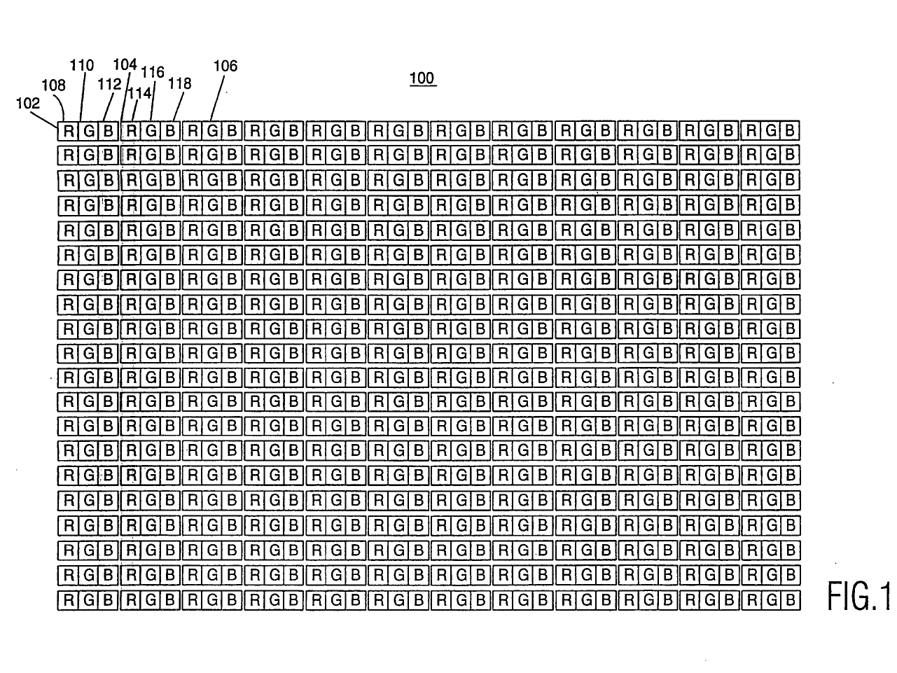

FIG. 1 schematically shows an embodiment of a color matrix display device;

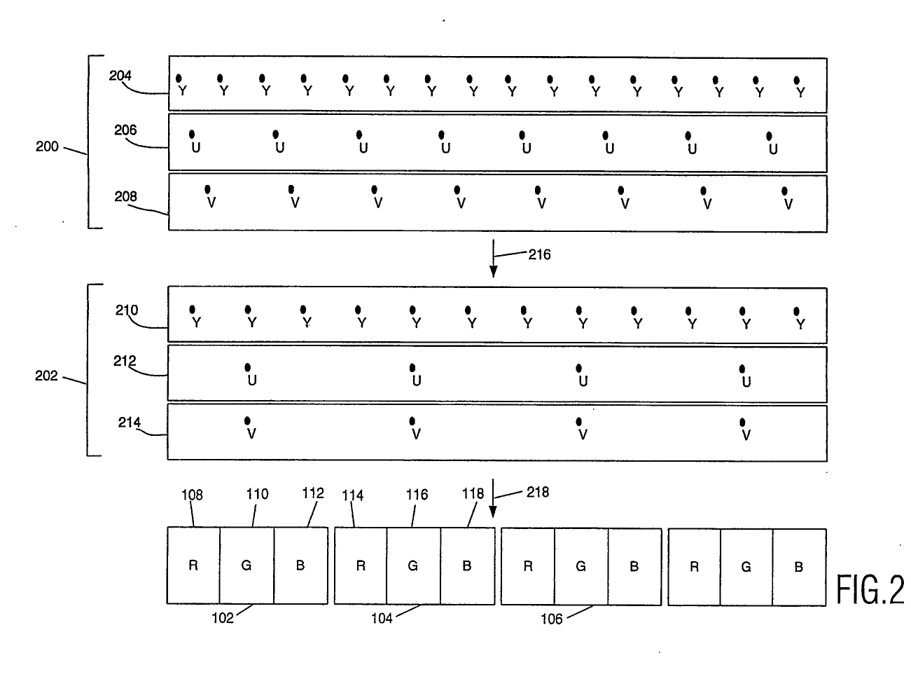

FIG. 2 schematically shows the processing steps according to the invention;

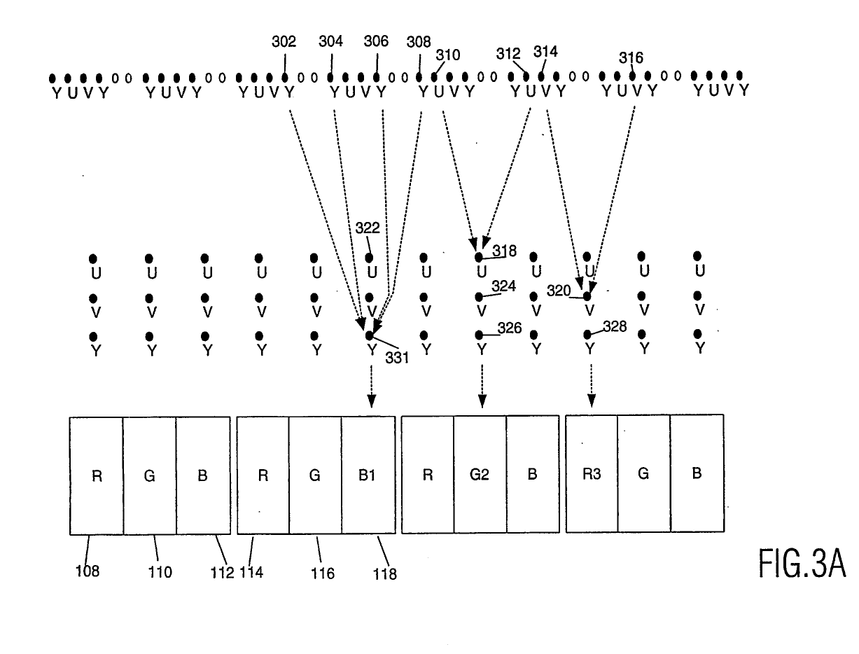

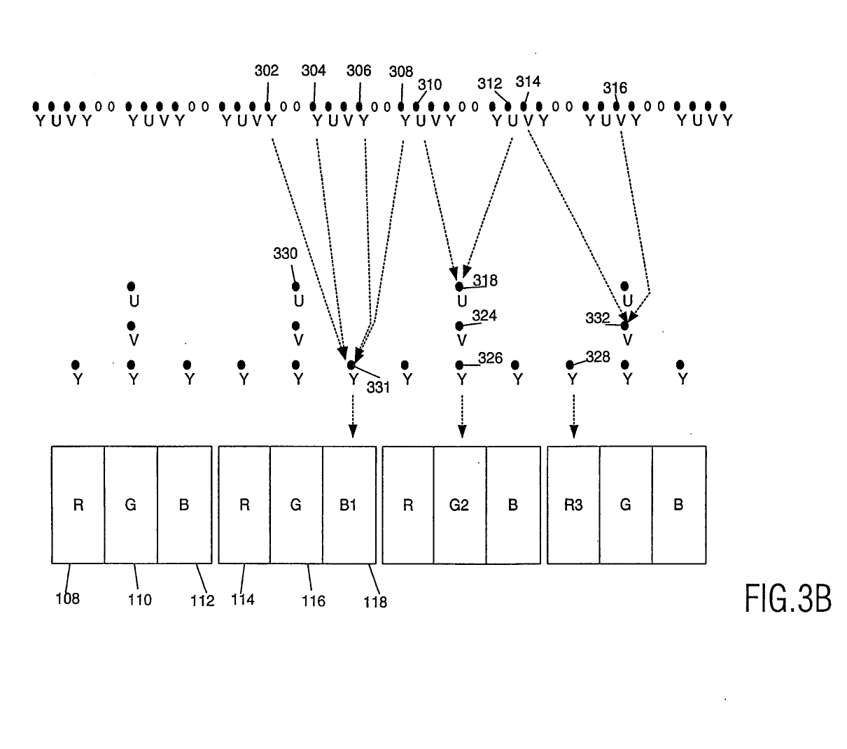

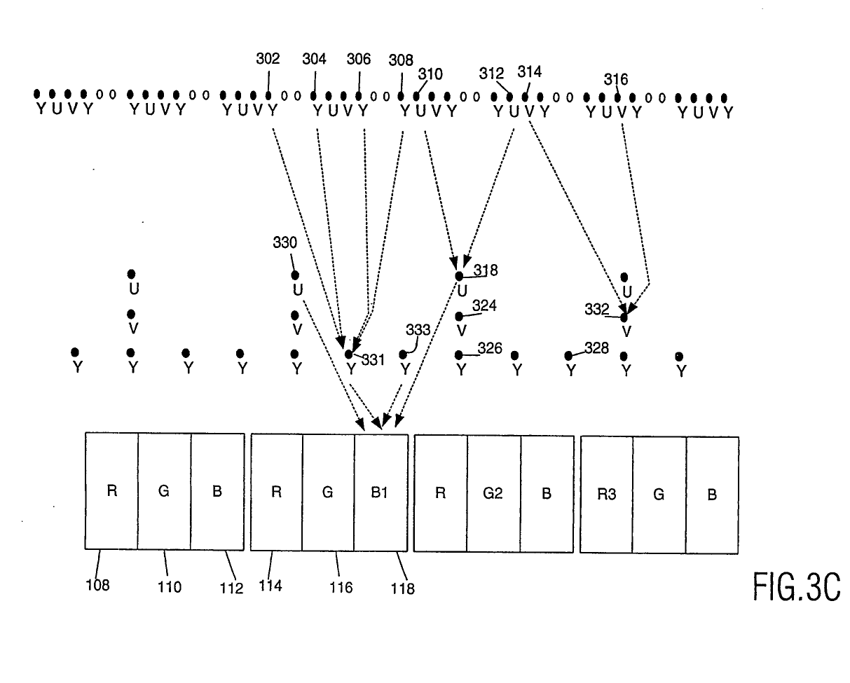

FIG. 3A schematically shows the scaling of an input image into Y, U and V samples at sub-pixel resolution;

FIG. 3B schematically shows the scaling of an input image into Y samples at sub-pixel resolution and U and V samples into pixel resolution;

FIG. 3C schematically shows the interpolation of Y, U and V samples to calculate the R, G, and B sub-pixel values;

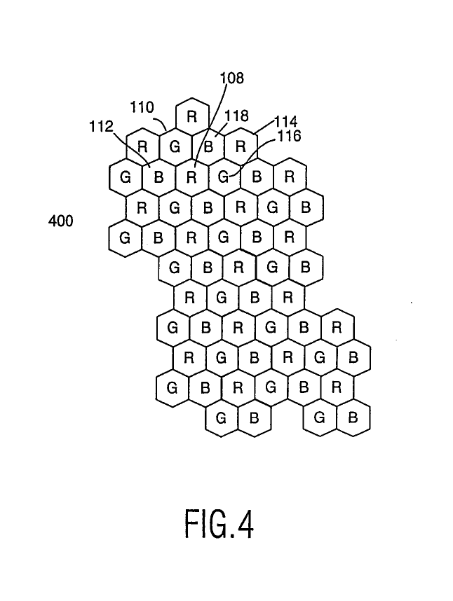

FIG. 4 schematically shows a delta-nabla pixel arrangement;

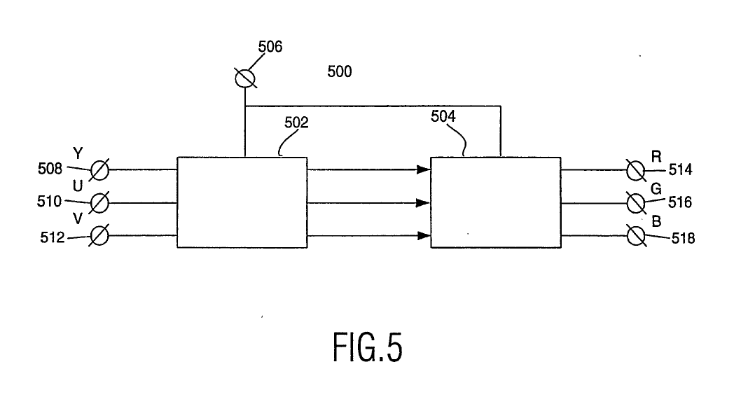

FIG. 5 schematically shows an embodiment of the display processing unit according to the invention; and

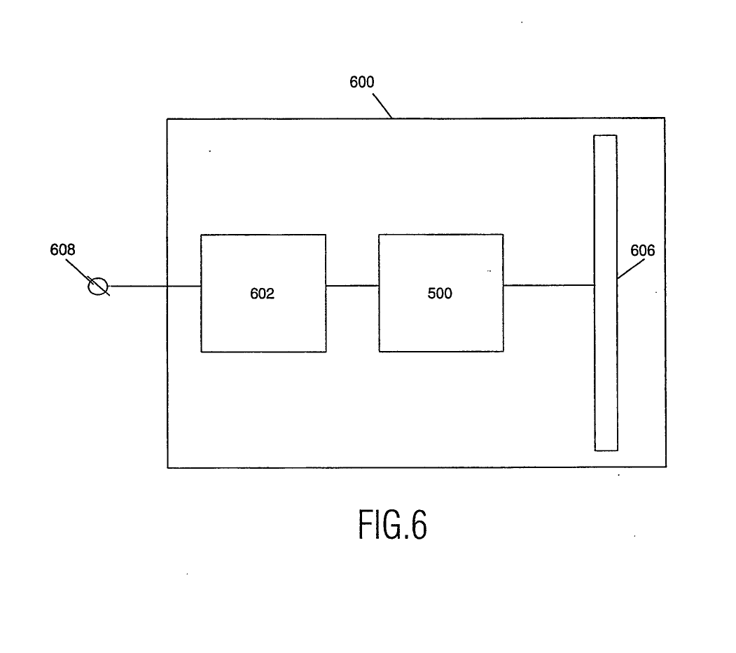

FIG. 6 schematically shows an embodiment of the display apparatus according to the invention.

Corresponding reference numerals have the same meaning in all of the Figs.

FIG. 1 schematically shows an embodiment of a color matrix display device 100. A color matrix display device 100 is a 2-dimensional arrangement of discrete luminous pixels 102-106 that together can display an image. The amount of image detail that can be produced by a matrix display device 100 depends largely on the number of pixels 102-106. To address each pixel in the color matrix display device 100, i.e. control the generated light intensity, a matrix display device 100 contains a matrix of row- and column electrodes to define a co-ordinate system on the color matrix display device 100 in which each pixel 102-106 is located. The intensity of each pixel 102-106 can then be controlled by applying an appropriate voltage or current to each pixel 102-106 individually via the row and column electrodes. To display a full color image, the color matrix display device 100 needs to be able to generate light of at least three primary colors, usually red, green and blue. By mixing these primary colors with different intensities, a full color gamut, spanned by the primary colors can be generated. Since a matrix display device 100 consists of discrete elements of which only the intensity can be controlled, each pixel 102-106 has to contain a number of sub-pixels 108-118 that can generate these primary colors with an intensity determined by the image signal. When the sub-pixels 108-118 are small enough, the human visual system is not capable of distinguishing the individual sub-pixels 108-118, and consequently the primary colors are blended together to form the intended color at the position of the full color pixel.

For the sake of simplicity, it will be assumed that there are equal numbers of each primary sub-pixel on the display. With equal numbers of sub-pixels, the full color pixels 102-106 can be easily defined, and each full color pixel contains exactly three sub-pixels 108-118. There is however a certain degree of freedom in this choice of grouping. Hence also for e.g. a Pentile with 2×G, 2×R, 1×B or an RGBW (white) configuration the method according to this invention is applicable.

In the color matrix display device 100 shown in FIG. 1 sub-pixels 108-118 have been combined in a red, green and blue order to a full color pixel. But the choice could also have been different, for instance in the order of green, blue and red, which shifts all pixels ⅓ of a pixel distance to the right. This already indicates that it is possible to position a piece of full color information with a higher accuracy than the pixel distance indicates, without introducing color errors, because still a red, green and blue sub-pixel are used to build a full color.

The sub-pixels 108-118 each have a different position, and if the color of the sub-pixels 108-118 could be neglected, the resolution would be three times that of the color matrix display device 100, e.g. in the horizontal direction. However, in principle the color of the sub-pixels 108-118 cannot be neglected. If a matrix display device which does not perform an anti-alias or low pass-filtering, is provided with a black and white signal, i.e. only containing gray levels, at three times the resolution, very annoying color artifacts appear.

The resolution of a color matrix display device 100 is higher than the number of full color pixels indicate, as long as the position of the sub-pixels 108-118 is taken into account. To achieve the higher resolution, the value of the video signal at the sub-pixel position is required in stead of at the full color pixel positions. This procedure is called sub-pixel sampling. Therefore, new samples must be calculated at these positions. The general method to achieve this is sample rate conversion and is explained in EP 0346621 and in “Displaced filtering for patterned displays”, by C. Betrisey et al. in SID 2000 Digest, pages 275-277. It is also indicated that polyphase filters are very appropriate for this.

FIG. 2 schematically shows the processing steps 216 and 218 according to the invention. An image 200 comprises a luminance component 204, a first color difference component 206 and a second color difference component 208. These components have Y, U and V samples, respectively. In general, the positions of these samples do not correspond with the positions of the sub-pixels 108-118 of the color matrix display device 100. First a scaling step is performed to scale the image 200 to an intermediate image 202 comprising an intermediate luminance component 210 having a sub-pixel resolution. The first color difference component 206 is scaled to the first intermediate color difference component 212 having a pixel resolution. The second color difference component 208 is scaled to the second intermediate color difference component 214 having a pixel resolution. After that a conversion step 218 is performed to convert the intermediate image 202 to values of the sub-pixels 108-118.

FIG. 3A schematically shows the scaling of an input image with input Y, U and V samples 302-316 into intermediate Y , U and V samples 318-331 at sub-pixel resolution. Besides that the conversion of the intermediate Y, U and V samples 318-331 into the R, G, and Bsub-pixel values is also shown. The intermediate Y, U and V samples 318-331 are calculated by means of sub-sampling. E.g. intermediate Y sample 331 is based on input Y samples 302-308, intermediate U sample 318 is based on input U samples 310 and 312, and intermediate V sample 320 is based on input V samples 314 and 316. The positions of the intermediate Y, U and V samples 318-331 correspond to the positions of the red, green and blue sub-pixels 108-118. Hence, the values R, G, and B of the sub-pixels can be calculated directly:

R₃=Y+1.4V, with Y sample 328 and V sample 320;

G₂=Y−0.332U−0.712V, with Y sample 326, V sample 324 and U sample 318; and

B₁=Y+1.78U, with Y sample 331 and U sample 322.

FIG. 3B schematically shows the scaling of an input image with input Y, U and V samples 302-316 into intermediate Y samples 326,328 and 331 at sub-pixel resolution and U samples 318 and 330 and V samples 332 and 324 into pixel resolution. The intermediate Y, U and V samples 318-331 are calculated by means of sub-sampling. The positions of the intermediate Y samples 326,328 and 331 correspond to the positions of the red, green and blue sub-pixels 108-118, but the intermediate U 318,330 and V samples 332,324 correspond to the central pixel positions of the pixels. Hence, the values R, G, and B of the sub-pixels can be calculated directly:

R₃=Y+1.4V, with Y sample 328 and V sample 332;

G₂=Y−0.332U−0.712V, with Y sample 326, V sample 324 and U sample 318; and

B₁=Y+1.78U, with Y sample 331 and U sample 330.

FIG. 3C schematically shows the interpolation of Y, U and V samples to calculate R, G, and B sub-pixel values. The values of the intermediate Y, U and V samples are calculated as described in connection with FIG. 3A. The positions of the intermediate Y samples 326,328 and 331 do not correspond to the positions of the red green and blue sub-pixels 108-118. Also the intermediate U samples 318 and 330 and V samples 332 and 324 do not correspond to the central pixel positions. It is possible to calculate the values R, G, and B of the sub-pixels as described in connection with FIG. 3B. That means by taking the intermediate Y, U and V samples which are closest to the red green and blue sub-pixel positions. Another approach is based on interpolation, e.g.

B₁=αY₁+(1−α)Y₂+1.78(βU₁+(1−β)U₂),

with Y₁ sample 331, Y₂ sample 333, U₁ sample 330 and with U₂ sample 318. α and β are related to the offset between the positions of the intermediate samples and the sub-pixel positions. The simple interpolation in the YUV-RGB conversion will generally have a low-pass effect, for which can be compensated in the scaling filter characteristic such that the response of the scaling-interpolation cascade substantially equals one.

FIG. 4 schematically shows a delta-nabla pixel arrangement 400. Up till now, the general principle has been explained, and where illustrated, a “vertical stripe” arrangement has been used. Of course, this is not the only color sub-pixel arrangement. Next the implications of sub-pixel scaling on the so-called delta-nabla arrangement will be described. FIG. 4 shows the delta-nabla arrangement, and a typical grouping of three sub-pixels 108-118 into full color pixels. The name “delta-nabla” comes from the typical form of this grouping. The sub-pixels are situated on a quincunx, or hexagonal, lattice, while the relative displacement is still ⅓ of the horizontal distance between sub-pixels of the same color. I.e. it is basically the same as the “vertical stripe” arrangement, but where each odd pixel on a row has half a row spacing offset, and the pixel shape is changed accordingly. Many other shapes, e.g. square or diamond are also possible in the delta-nabla arrangement, with the hexagon as the best approximation to a circle. The distribution of sub-pixels 108-118 in this arrangement is truly 2-Dimensional, because any color sub-pixel 108-118 is surrounded by only sub-pixels of the two other colors. Therefore a resolution gain is present in all directions, in stead of only in horizontal direction with the vertical stripe arrangement. However, to scale to such an hexagonal arrangement, is not a trivial task. 2-Dimensional non-separable filtering and co-ordinate transformations are usually involved. Nevertheless, the basic theory of sub-pixel sampling also holds for the delta-nabla arrangement, and as long as the most serious color aliasing is removed, the gain in resolution is also present. It is possible to scale from a rectangular, i.e. conventional row-column lattice to an hexagonal lattice using polyphase filters in a simple way, by recognizing that the hexagonal lattice is created by taking a rectangular lattice, and shifting samples on odd lines by half a pixel distance. Since the sub-pixels are displaced horizontally, first the input signal is scaled to twice the number of rows of the display, using a normal polyphase scaling method. Then the odd and even lines with different horizontal offsets, and of course different phases for RGB, are scaled. Finally, the samples are combined again along the rows as defined by the display electrodes, in order to get the correct values at the correct position when the color matrix display device is addressed using these rows and columns. Due to this “packing” step, the Nyquist frequencies in horizontal and vertical direction are changed. That means vertical samples become horizontal samples, and the filter must be adapted accordingly. This means that the vertical filter should have its cut-off frequency roughly at twice the Nyquist rate, while the horizontal filter cuts off at half the Nyquist rate. Of course these cut-off frequencies can be optimized for sharpness versus color errors. It must be noted that this approach does not result in a completely correct 2-dimensional filter response, because the diagonal frequencies are only suppressed if the corresponding horizontal and vertical frequencies do so, and a truly hexagonal band-limitation cannot be obtained. Nevertheless this does result in a very simple sub-pixel scaling method for delta-nabla displays. When the Y signal is again oversampled compared to the pixel resolution, e.g. by taking twice the horizontal resolution, the interpolation in the YUV-RGB conversion can create a true diagonal bandlimitation. This can be achieved by using a simple 2D filter, e.g. [−1 2 −1; 1 6 1]

FIG. 5 schematically shows an embodiment of the display processing unit 500 according to the invention. The display processing unit 500 comprises:

a filter 502 for scaling an input image to an intermediate image comprising an intermediate luminance component having a sub-pixel resolution which is related to a number of sub-pixels of the color matrix display device; and

a converter 504 for converting the intermediate image to values of the sub-pixels of a color matrix display device.

At the input connectors 508-512 of the display processing unit 500 the luminance component Y, a first color difference component U and a second color difference component V of the video signals are provided. The display processing unit 500 provides a first color component R, a second color component Gand a third color component Bat the output connectors 514-518, respectively. The filter 502 and the converter 504 comprise a control interface 506 to control the scaling. Via this control interface 506 data is provided about e.g. the inter-pixel distances and sub-pixel positions. The working of the display processing unit 500 is conform as described in any of the FIGS. 3A, 3B or 3C.

For the application of scaling a digital image, polyphase filters are known to be very efficient. The main principle of a polyphase filter is that the input signal is first up-sampled by inserting zeros in between samples. Then a low-pass filter is applied to interpolate the inserted samples and finally the necessary samples at the new resolution are then extracted from this signal by a down-sampling step. Since only the samples at the new resolution are needed, only a part of the samples after low-pass filtering are used, and computations can be saved by not calculating the samples in the first place. Furthermore, since the inserted samples have value zero, they can also be omitted from the calculations. A polyphase filter basically comprises one large low-pass filter, of which only a subset, i.e. a “phase” of the coefficients are used to calculate a new sample. The choice of this phase depends on the position of the sample in the new resolution image, relative to the samples in the input image. Furthermore, a polyphase filter can usually be separated in a horizontal and vertical stage, simplifying calculations even more. There are two different implementations of polyphase filters, the normal form and the transposed form, which are most suitable for up-scaling and downscaling, respectively. They differ from each other because for up-scaling, the signal must be limited to the Nyquist frequency of the input, and for downscaling, the signal must be limited to the Nyquist frequency of the output. In the normal form, an output sample is calculated as a weighted sum of input samples, while the transposed form calculates an output sample by adding each input sample to a number of output samples. In this way, no input samples are “missed”, i.e. no aliasing occurs when the downscaling factor is large.

FIG. 6 schematically shows an embodiment of the display apparatus 600 according to the invention. The display apparatus 600 comprises a:

a receiver for receiving video signals representing images. The video signals can be from a broadcast or from a storage medium as DVD or video cassette;

a display processing unit 500 as described in connection with FIG. 5; and

a color matrix display device as described in connection with FIG. 1.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of displaying an image (200) on a color matrix display device (100) which comprises multiple pixels (102-106), each comprising sub-pixels (108-118) corresponding to predetermined colors, the image being represented by an image signal comprising a luminance component (204), a first color difference component (206) and a second color difference component (208), the method comprising:
a scaling step (216) to scale the image (200) to an intermediate image (202) represented by a further image signal comprising an intermediate luminance component (210), a first intermediate color difference component (212) and a second intermediate color difference component (214), with scaling of the luminance component related to a sub-pixel resolution which is related to a number of sub-pixels (108-118) of the color matrix display device (100);
a conversion step (218) to calculate signal values for a particular pixel to be provided to respective sub-pixels (108-112) of the particular pixel based on samples of the intermediate luminance component (210), the first intermediate color difference component (212) and the second intermediate color difference component (214);
a display step in which the signal values are provided to the respective sub-pixels (108-112) of the particular pixel.

2. A method of displaying an image as claimed in claim 1, characterized in that the first color difference component (206) and the second color difference component (208) are scaled to the first intermediate color difference component (212) and the second intermediate color difference component (214) respectively, both having a pixel resolution of the color matrix display device (100), which is related to a number of pixels of the color matrix display device (100).

3. A method of displaying an image as claimed in claim 1, characterized in that a particular signal value for a particular sub-pixel (118) is calculated based on a first sample (331) of the intermediate luminance component (210) and a second sample (330) of the first intermediate color difference component (212).

4. A method of displaying an image as claimed in claim 3, characterized in that in the scaling step (216) the first sample (331) is calculated by taking into account a location of the particular sub-pixel (118).

5. A method of displaying an image as claimed in claim 1, characterized in that the particular signal value of the particular sub-pixel (118) is calculated based on an interpolation of multiple samples (331, 333) of the intermediate luminance component (210).

6. A display processing unit (500) for displaying an image (200) on a color matrix display device (100) which comprises multiple pixels (102-106), each comprising sub-pixels (108-118) corresponding to predetermined colors, the image being represented by an image signal comprising a luminance component (204), a first color difference component (206) and a second color difference component (208), the display processing unit comprising:
a filter (502) for scaling the image (200) to an intermediate image (202) represented by a further image signal comprising an intermediate luminance component (210), a first intermediate color difference component (212) and a second intermediate color difference component (214), with scaling of the luminance component related to a sub-pixel resolution which is related to a number of sub-pixels (108-118) of the color matrix display device (100);
a converter (504) for calculating signal values for a particular pixel to be provided to respective sub-pixels (108-112) of the particular pixel based on samples of the intermediate luminance component (210), the first intermediate color difference component (212) and the second intermediate color difference component (214);
a display driver for providing the signal values to the respective sub-pixels (108-112) of the particular pixel.

7. A display processing unit (500) for displaying an image as claimed in claim 6, characterized in that the filter (502) is a polyphase filter.

8. A display apparatus (600) comprising:
a receiver (602) for receiving an image;
a display processing unit (500) for displaying an image (200) on a color matrix display device (100) which comprises multiple pixels (102-106), each comprising sub-pixels (108-118) corresponding to predetermined colors, the image being represented by an image signal comprising a luminance component (204), a first color difference component (206) and a second color difference component (208), the display processing unit comprising:
a filter (502) for scaling the image (200) to an intermediate image (202) represented by a further image signal comprising an intermediate luminance component (210), a first intermediate color difference component (212) and a second intermediate color difference component (214), with scaling of the luminance component related to a sub-pixel resolution which is related to a number of sub-pixels (108-118) of the color matrix display device (100);
a converter (504) for calculating signal values for a particular pixel to be provided to respective sub-pixels (108-112) of the particular pixel based on samples of the intermediate luminance component (210), the first intermediate color difference component (212) and the second intermediate color difference component (214);
a display driver for providing the signal values to the respective sub-pixels (108-112) of the particular pixel; and
the color matrix display device.

9. A display apparatus (600) as claimed in claim 8, characterized in that it is a Television.
